(19) United States
(12) Patent Application Publication
(10) Pub. No.: US 2020/0238170 A1
(43) Pub. Date: Jul. 30, 2020

(54) ELECTRONIC GAMING BOARD DEVICE FOR A MULTI-PLAYER GAME

(71) Applicants: Monthir ALSAID, Dearborn, MI (US); Mahmoud ALSAID, Dearborn, MI (US)

(72) Inventors: Monthir ALSAID, Dearborn, MI (US); Mahmoud ALSAID, Dearborn, MI (US)

(21) Appl. No.: 16/751,540

(22) Filed: Jan. 24, 2020

Related U.S. Application Data
(60) Provisional application No. 62/796,088, filed on Jan. 24, 2019.

(51) Int. Cl. A63F 13/30; A63F 13/213; A63F 13/2145; A63F 13/87

(52) U.S. Cl. CPC A63F 13/30; A63F 13/87; A63F 13/2145; A63F 13/213

(57) ABSTRACT

An electronic board game device is disclosed. The electronic gaming board device includes a gaming board and a common display positioned substantially on a central portion of the gaming board. The common display is visible to a plurality of players competing in the multi-player game. The electronic gaming board device includes a plurality of player-specific displays. Each player-specific display of the plurality of player-specific display is swingably or pivotally mounted on a peripheral portion of the gaming board at player positions associated with the plurality of players. The player-specific display includes private and public displays. In a playing mode of the multi-player game, the private display is oriented towards a player and the public display is oriented towards competing players of the player in the multi-player game. The player-specific display is configured to open and close through a hinge mechanism.

### TECHNICAL FIELD

The present disclosure relates the field of board and tabletop games and, more particularly to, systems and methods for playing a multi-player game using an electronic gaming board device integrated with gaming and chatting session.

### BACKGROUND

Board games have been played in most societies throughout history. For instance, if players are family members, the board games ensure the quality family time. Some board games (e.g., chess) depend completely on a player's skill whereas several other board games (e.g., monopoly game) are played and decided purely by luck. Traditional multi-player board and card games, such as, Scrabble, Monopoly, Risk, Chess, Texas Hold'em, etc., and more recent designer board games such as Settlers of Catan, Apples to Apples, Uno, etc., promote social interaction of two or more players as they involve counters or pieces that are moved or placed on a pre-marked surface (board). The board games help in memory formation, reducing stress, speeding up response and lowering blood pressure. They also help children to build several skills at the same time.

With the recent technological advancement, players are attracted to video games (e.g., gaming console and computer games) which include computer playing as one or more opponents. Further, the board games can now be played online against a computer and/or other players. However, these board games do not allow players to participate in real-time, or interact with each other while playing. Typically, for such interactions, the players must be physically present around the board game. However, this may not be possible in several instances as the players may be located in different geological positions.

Therefore, there is a need for techniques that can overcome one or more limitations stated above in addition to providing other technical advantages.

### SUMMARY

Various embodiments of the present disclosure provide systems and methods for a multi-player game using an electronic gaming board device integrated with gaming and chatting session.

In one embodiment, an electronic gaming board device for a multi-player game is described. The electronic gaming board device includes a gaming board, a common display, and a plurality of player-specific displays. The common display is positioned substantially in a central portion of the gaming board. The common display is visible to a plurality of players competing in the multi-player game. Each player-specific display of the plurality of player-specific display is mounted on a peripheral portion of the gaming board at player positions associated with the plurality of players. Further, each player-specific display of the plurality of player-specific displays includes a private display and a public display. In a playing mode of the multi-player game, the private display is oriented towards a player and the public display is oriented towards competing players of the player in the multi-player game.

In another embodiment, a non-transitory computer readable storage medium including computer executable code for playing a multi-player game using an electronic gaming board device including a gaming board. The computer executable code being executed by a processor causes the processor of the electronic gaming board device to perform at least display a list of multi-player games on a private display of a player-specific display associated with a player. The player-specific display is positioned on a peripheral portion of the gaming board. The player-specific display includes the private display and a public display. The private display is oriented towards the player and the public display is oriented towards competing players of the player in the multi-player game. The processor is caused to generate a published view of the multi-player game on a common display. The common display is positioned substantially in a central portion of the gaming board. The processor is caused to display player profiles of a list of active players, who want to join the multi-player game, on the private display of the player and provide an input interface on the private display for selecting the competing players from the list of active players for the multi-player game. The processor is caused to display a private view on the private display associated with the player for playing the multi-player game. The processor is further caused to facilitate an interactive video chatting session for engaging the player with the competing players during playing the multi-player game and display game score data of the player and the competing players on corresponding public displays during playing the multi-player game.

In yet another embodiment, an electronic gaming board device for a multi-player game is described. The electronic gaming board device includes a gaming board, a common display, and a plurality of player-specific displays. The common display is positioned on a substantially central portion of the gaming board. The common display is visible to a plurality of players competing in the multi-player game. Each player-specific display of the plurality of player-specific displays is mounted on a peripheral portion of the gaming board at player positions associated with the plurality of players. Each player-specific display of the plurality of player-specific displays includes a private display and a public display. Each player-specific display is swingably mounted on the peripheral portion of the gaming board using a first hinge. The private display and the public display of each player-specific display are swingably coupled together using a second hinge. In a playing mode of the multi-player game, the private display is oriented towards a player and the public display is oriented towards competing players of the player in the multi-player game. Further, the electronic gaming board device includes a memory storing executable instructions and a processor configured to execute the instructions stored in the memory to cause the electronic gaming board device to perform at least display a list of multi-player games on the private display associated with the player for selecting the multi-player game, generate a published view of the multi-player game on the common display, and display player profiles of a list of active players, who want to join the multi-player game, on the private display of the player. The electronic gaming board device is further caused to provide an input interface on the private display for selecting the competing players for the multi-player game and display game score data of the player and the competing players on corresponding public displays during playing the multi-player game.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a block diagram representation of an electronic gaming board device for a multi-player game, in accordance with an example embodiment of the present disclosure;

FIG. 3A illustrates a perspective top view of the electronic gaming board device for the multi-player game, in accordance with an example embodiment of the present disclosure;

FIG. 3B illustrates a schematic view of the electronic gaming board device (as shown in FIG. 3A) depicting a plurality of player-specific displays in a closed position, in accordance with an example embodiment of the present disclosure;

FIG. 3C illustrates a schematic view of the electronic gaming board device (as shown in FIG. 3A) depicting the plurality of player-specific displays in an open position, in accordance with an example embodiment of the present disclosure;

FIG. 4 is a process flow diagram representation of facilitating a gaming and chatting session for players during playing the multi-player game using the gaming board device, in accordance with an example embodiment of the present disclosure;

FIGS. 5A, 5B, and 5C, collectively, represent example representation of user-interfaces (UI) displayed on a private display associated with each player-specific display, in accordance with an example embodiment;

FIG. 6 represents an example representation of a UI displayed on a public display associated with each player-specific display of players playing the multi-player game, in accordance with an example embodiment of the present disclosure;

FIG. 7 is a flow graph of a method for playing the multi-player game by using the electronic gaming board device, in accordance with an example embodiment of the present disclosure;

FIG. 8 is a simplified block diagram of a gaming server, in accordance with an example embodiment of the present disclosure; and

FIG. 9 is a simplified block diagram of the electronic gaming board device, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “player-specific” used throughout the description refers to a display unit for displaying private information related to a player of a multi-player game (e.g., the Scrabble tiles or Texas Hold'em cards), to perform private game activities (e.g., consulting English dictionary in Scrabble, and taking notes in the Clue game, or Simulate few chess moves). The scope of the present disclosure is not limited by the number of player-specific displays on the gaming board.

### Overview

Various example embodiments of the present disclosure provide methods, systems, user devices and computer program products for an electronic gaming board device, that enables multiple players to digitally play a social game using multiple displays screens while allowing the players to electronically interact with each other.

In one embodiment, the electronic gaming board device is configured to include a gaming board for providing a housing for one or more components of the electronic gaming board device. The electronic gaming board device further includes a common display. The common display is positioned on a substantially central portion of the gaming board. The common display is visible to a plurality of players associated with the electronic gaming board device. The electronic gaming board device includes a plurality of player-specific displays. The plurality of player-specific displays opens and closes through a hinge mechanism. Each player-specific display of the plurality of player-specific display is swingably or pivotally mounted on a peripheral portion of the electronic gaming board device using a first hinge. Further, each player-specific display of the plurality of player-specific displays includes a private display and a public display. The private display and the public display of each player-specific display are swingably coupled together using a second hinge. The first hinge and the second hinge are configured to operate each player-specific display in a closed position and an open position. In the closed position, the private display and the public display of each player-specific display overlap with each other and are enveloped into the electronic gaming board device. In the open position, the private display and the public display of each player-specific display are opened angularly along the second hinge of the electronic gaming board device, and this position is also referred to as playing mode. In the playing mode, the private display is oriented towards a player of the plurality of players and the public display is oriented towards competing players of the plurlaity of players in the multi-player game.

The electronic gaming board device further includes a memory storing executable instructions and a processor configured to execute the instructions stored in the memory for playing the multi-player game using the electronic gaming board device. In the playing mode, the electronic gaming board device is configured to display a list of multi-player games on the private display associated with the player for selecting the multi-player game. The electronic gaming board device is configured to display a published view of the multi-player game on the common display. Further, the electronic gaming board device is configured to search a list of active players, who wants to join the multi-player game, via a gaming network and display player profiles of the list of active players on the private display. The electronic gaming board device is configured to provide an input interface on the private display for selecting competing players from the list of active players for the multi-player game.

Upon selection of the competing players, the electronic gaming board device is configured to display a private view on the private display associated with the player for playing the multi-player game. Moreover, the electronic gaming board device is configured to facilitate an interactive video chatting session for engaging the player with the competing players. Consequently, the interactive video chatting session provides a smart and interactive platform to the plurality of players of the multi-player game. The electronic gaming board device is configured to display game scores of the player and the competing players on corresponding public displays while playing the multi-player game. The electronic gaming board device is configured to store at least the game scores and game activities of the player and the competing players associated with the multi-player game. The game scores and the game activities are stored for maintaining statistics of game play of the player and the competing players of the multi-player game.

Various embodiments of the present disclosure offer multiple advantages and technical effects. For instance, the present disclosure describes the electronic gaming board device that creates a new platform for gaming, social media and application ideas. The electronic gaming board device facilitates the plurality of players to play the multi-player game, the plurality of players is located either at different locations or at the same location. The electronic gaming board device provides a gaming platform for the multi-player game which brings the plurality of players together.

In addition to the above, the electronic gaming board device facilitates a group chatting, live streaming experience, and a gaming session among the plurality of players of the multi-player game. Thus, the electronic gaming board device provides a virtual experience to the plurality of players connected online for playing the multi-player game.

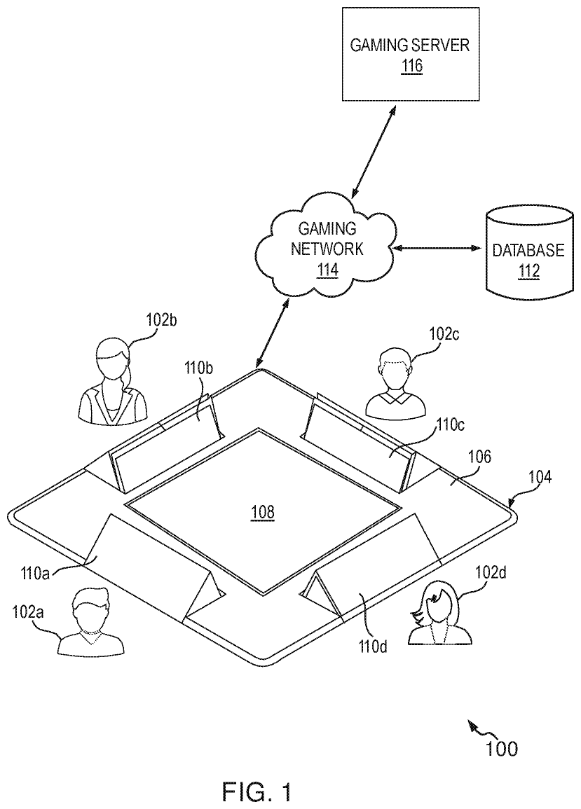

Various example embodiments of present disclosure are described hereinafter with reference to FIGS. 1 to 9.

FIG. 1 illustrates an example representation of an environment 100, in which at least some example embodiments of the present disclosure can be implemented. The environment 100 includes an electronic gaming board device 104 (hereinafter interchangeably referred to as “gaming board device 104”), a plurality of players 102a, 102b, 102c and 102d, a database 112, and a gaming network 114. An example of the gaming board device 104 is a touch screen device. The gaming network 114 may include, without limitation, a local area network (LAN), a wide area network (WAN) (e.g., the Internet, etc.), a mobile network, a virtual network, and/or another suitable public and/or private network capable of supporting communication among two or more of the parts or players illustrated in FIG. 1, or any combination thereof. For example, the gaming network 114 may include multiple different networks, such as a private network made accessible by the electronic gaming board device 104. Various entities in the environment 100 may connect to the gaming network 114 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

Further, the gaming board device 104 may be equipped with an instance of a computer-implemented application, such as a gaming application installed therein. The gaming application is a set of computer executable codes configured to render a game layout on the gaming board device 104 for the multi-player game.

In one embodiment, the gaming application may be embodied in the database 112 associated with a server, such as the gaming server 116. The gaming application enables the player (i.e., “the player 102a”) to play the multi-player game with the competing players (i.e., “the players 102b-102d”) either located in remote locations, or present physically. The gaming board device 104 may communicate with the gaming server 116 through the gaming application via the gaming network 114. In one embodiment, the gaming server 116 enables players to resume a game in progress at a later time (tracking) and maintains statistics of the game play.

The database 112 stores information of the board game that have been played previously on the gaming board device 104.

Additionally, it shall be noted that four players, such as the plurality of players 102a-102d are shown for exemplary purposes only and there can be more or less number of players available in the multi-player game without limiting the scope of the present disclosure.

In one embodiment, the gaming board device 104 is a smart board that creates a new platform for gaming, social media and application ideas. It is specifically used to revive family board game time. A board game may be defined as a tabletop game that includes pieces that are moved or placed on a pre-marked “board” based on specific rules. The gaming board device 104 stores a list of board games digitally. Examples of the list of board games include, but are not limited to, Cards, Monopoly, Scrabble, Checkers, Cluedo, Chess and Risk.

The gaming board device 104 includes a gaming board 106, a common display 108, and a plurality of player-specific displays 110a-110d.

In one non-limiting example, the gaming board device 104 is a square touch screen tablet with appropriate dimensions of 20×20 inches and ¼ inch thickness. It may be understood that the said dimensions are merely an approximate estimation to which the disclosed subject matter is not limited. In one non-limiting example, the touch screen tablet is a mobile device/portable computer that uses a touch screen as its primary input device. The gaming board device 104 is equipped with a rechargeable battery (not shown in FIG. 1) in a thin package.

The common display 108 may be integrated substantially in a central portion of the gaming board 106. The common display 108 is configured to display a game layout visible to the plurality of players 102a-102d associated with the multi-player game. The common display 108 may be a single display unit, or a plurality of display units that can be coupled to each other.

The plurality of player-specific displays 110a-110d may be mounted on peripheral portions of the gaming board 106. In one embodiment, the player-specific displays 110a-110d may be mounted symmetrically to each other on the peripheral portions of the gaming board 106. The plurality of player-specific displays 110a-110d are associated with the plurality of players 102a-102d. The plurality of player-specific displays 110a-110d may be physically pre-attached to the gaming board 106 by some fastening mechanism, such as, a hinge, a flexible backing tape, etc., or they may be removably attachable to the gaming board 106.

In one embodiment, the player-specific display (e.g., “player-specific display 110a”) may include at least a private display and a public display. In other words, the player-specific display is a double sided display screen. The double sided display screen is designed with a touch screen display on an outer face facing towards the player (i.e., private display) and a non-touch screen display on an inner face facing towards competing players (i.e., public display) The private display may be configured to display private information such as, but not limited to, gaming strategies, browsing electronic dictionary, and game rules. The public display may be configured to display public information such as but not limited to a player's profile, game score data. Further, orientation and configuration of the player-specific display 110a including the private and the public displays are explained in detail in further sections.

The player (i.e., “the player 102a”) interacts with the common display 108 and the competing players (such as, for example, the players 102b, 102c, and 102d) in the multi-player game by providing an input on the private display of the player-specific display 110a. Alternatively, in some embodiments, the player 102a may provide an input on the common display 108 for interacting with the competing players in the multi-player game. The input may include, but is not limited to a touch input, voice input, gesture input.

It should be appreciated by those of ordinary skill in the art that FIG. 1 depicts the system in the viewable mechanism in an oversimplified manner and a practical embodiment may include additional components and suitably configured processing logic to support known or conventional operating features that are not described in detail herein.

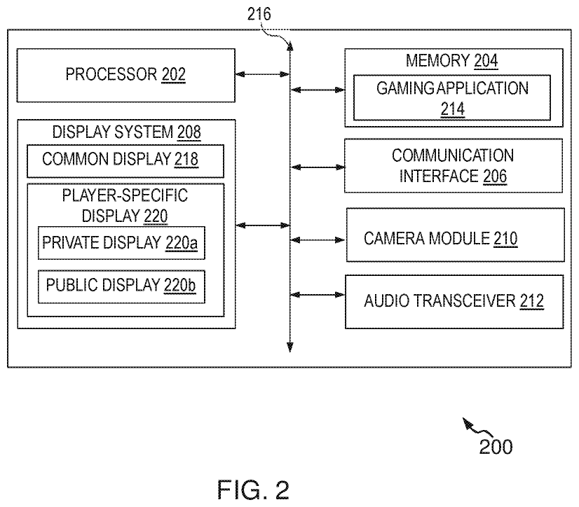

FIG. 2 illustrates a block diagram representation of an electronic gaming board device 200 for the multi-player game capable of implementing at least some embodiments of the present disclosure. For example, the electronic gaming board device 200 (interchangeably referred to as “the gaming board device 200”) may correspond to the gaming board device 104. The gaming board device 200 includes a processor 202, a memory 204, a communication interface 206, a display system 208, a camera module 210, and an audio transceiver module 212. The processor 202 is configured to host and manage a gaming application 214.

The processor 202 may be operatively coupled with the memory 204 including the executable instructions for the gaming application 214. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuitry such as, for example, an application specific integrated circuitry (ASIC), a field programmable gate array (FPGA), a microcontroller unit (MCU), a hardware accelerator, a special purpose computer chip, and the like.

The memory 204 may be any computer-operated hardware circuitry for storing and/or retrieving data, such as, but not limited to, the gaming application 214, a list of predefined multiplayer games, digitized gaming objects, gaming activities, and leaderboard of the multi-player game. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The communication interface 206 enables the gaming board device 200 to communicate with other entities over various types of wired, wireless or combinations of wired and wireless networks, such as for example, the Internet. In at least one example embodiment, the communication interface 206 includes a transceiver circuitry configured to enable transmission and reception of data signals over the various types of communication networks. In some embodiments, the communication interface 206 may include appropriate data compression and encoding mechanisms for securely transmitting and receiving data over the communication networks.

In an embodiment, various components of the gaming board device 200, such as the processor 202, the memory 204, the communication interface 206, the display system 208, the camera module 210, and the audio transceiver module 212 may be configured to communicate with each other via a centralized bus 216. The centralized bus 216 may be configured to provide or enable communication between the components of the gaming board device 200. In certain embodiments, the centralized bus 216 may be a central printed circuit board (PCB) such as a motherboard, a main board, a system board, or a logic board. The centralized bus 216 may also, or alternatively, include other printed circuit assemblies (PCAs) or communication channel media.

The display system 208 includes one or more display system such as a common display 218 and a player-specific display 220. The common display 218 is configured to display a game layout or a published view of the multi-player game visible to one or more players associated with the multi-player game. Further, the player-specific display 220 includes a private display 220a and a public display 220b. The private display 220a is configured to display private information such as, but not limited to, gaming strategies, browsing electronic dictionary, and game rules, and digitized gaming objects. The public display 220b is configured to display public information such as, but not limited to, player profiles, game score data, etc. In one example embodiment, the common display 218, and the private display 220a of the player-specific display 220 may be configured with touchscreen technology. In another example scenario, the public display 220b may also be configured with the touchscreen technology.

In some embodiments, the common display 218 and the player-specific display 220 of the display system 208 may be, but not limited to, a TFT-LCD (Thin film transistor-liquid crystal display), a Light-emitting diode display (LED), Plasma display panel (PDP), and Active Matrix Organic Light Emitting Diodes display (AMOLED) and the like.

Additionally, prior to starting the multi-player game using the gaming board device 200, the player (i.e., the player 102a) manually aligns the player-specific display 220 on the gaming board (i.e., the gaming board 106) for configuring the gaming board device 200 in a playing mode. For configuring the gaming board device 200 in the playing mode, the player manually aligns the private display 220a and the public display 220b with an angle between each other. In one embodiment, the processor 202 may be configured to automate the orientation of the player-specific display 220 for configuring the playing mode.

In the playing mode, the processor 202 is configured to display a list of predefined multi-player games on the private display 220a of the player-specific display 220 associated with the player 102a. In one example implementation, the list of multi-player games and graphic software associated with list of multi-player games are stored in the memory 204. Thereafter, the player 102a selects a multi-player game from the list of multi-player games. In response, the processor 202 is configured to generate a published view of the multi-player game selected by the player 102a on the common display 218.

Upon selection of the multi-player game, the processor 202 is configured to search online for active players, who want to join the multi-player game, via the gaming network 114. Thereafter, the processor 202 is configured to display players' profiles of a list of active players, who want to join the multi-player game, on the private display 220a of the player 102a. The player 102a provides an input on the private display 220a for selecting one or more players from the list of players. The one or more players correspond to the competing players (i.e., “players 102b-102d”) of the player 102a for the multi-player game. In one embodiment, the processor 202 is configured to send a game request to the competing players 102b-102d via the gaming network 114 based on the input received from the player 102a.

In one embodiment, the processor 202 is configured to enable an interaction of the player 102a with the competing players 102b-102d for the multi-player game via the gaming network 114. Thereafter, the processor 202 is configured to display player profiles of the competing players 102b-102d on corresponding public displays 220b-220d. For example, each player profile includes a profile photo and a name of the corresponding competing player.

Further, the processor 202 is configured to display on the private display 220a, at least: a player profile, game rules, game strategies, and digitized gaming objects associated with the player 102a. The player 102a provides an input on the private display 220a for playing the multi-player game with the competing players 102b-102d. In other words, the actions and/or moves related to the multi-player game may be selected by the player 102a on the private display 220a. The processor 202 is configured to manipulate and/or execute the action and/or moves on the common display 218 for playing the multi-player game with the competing players 102b-102d. In particular, the processor 202 is configured to exchange digitized gaming objects rendered on the private display 220a with the common display 218 based on the input provided by the player 102a which facilitate the player 102a to play the multi-player game with the competing players 102b-102d. In one embodiment, the processor 202 is configured to provide seamless movement of digitized gaming objects between player-specific displays associated with the plurality of players. The objects exchange depends on game rules. For example, the gaming objects can move as is (e.g., Monopoly money) or follow some transformation rule (e.g., flip Scrabble tile, show Poker card). The gaming objects exchange can trigger some game rule (e.g., decide on the winner in Card games). The gaming objects exchange can create unique experience like dice shake on the “player-specific display” (using the accelerometer) that virtually continues on the gaming board 104 taking into account the magnitude and direction of force applied by the user action. Example of gaming objects are tiles, cards, chips, money, drawings, avatars, etc.

The processor 202 is configured to trigger the camera module 210 in the playing mode. In an illustrative manner, the camera module 210 is mounted on the public display 220b of the player-specific display 220. The camera module 210 is configured to capture a real-time image of the competing players. The audio transceiver module 212 is configured for real-time audio transmission between the plurality of players who are playing the multi-player game. Thus, the camera module 210 and the audio transceiver module 212 are configured to provide an interactive video chatting platform on the public display 220b. The interactive video chatting platform provided by the processor 202 on the public display 220b engages the player 102a with the competing players 102b-102d in remote locations to converse while playing the multi-player game. In other words, the processor 202 is configured to provide the video chatting platform on the public display 220b which enables live-streaming of the competing players 102b-102d on the public display 220b during the multi-player game. Consequently, the live streaming experience provides a smart and interactive platform to the players 102a-102d of the multi-player game.

In one example embodiment, the plurality of players 102a-102d of the multi-player game may present physically at player positions associated with the gaming board device 200. In an embodiment, the player 102a may provide an input on the private display 220a for playing the multi-player game with the competing players 102b-102d.

Moreover, the processor 202 is configured to continuously track online connectivity (interaction) of the plurality of players 102a-102d during playing the multi-player game. In one example scenario, if the processor 202 determines that the connectivity of a player (e.g., “the player 102c”) is lost and/or disconnected during the multi-player game, the processor 202 is configured to disconnect an online connection to drop the player 102c from playing the multi-player game. In another example scenario, if the processor 202 determines that the connectivity of the player 102c is lost, the processor 202 may be configured to communicate with a gaming server (i.e., “the gaming server 116”) via the gaming network 114 for resuming the multi-player game in progress based on tracking the connectivity of the player 102c. In one embodiment, the processor 202 is configured to receive a request from the player 102c to quit the game. Thus, upon receiving the request from the player 102c, the processor 202 is configured to disconnect the online connection of the player 102c to drop from the multi-player game.

In one embodiment, the processor 202 is configured to display game scores of the plurality of players 102a-102d on their corresponding public displays 220b during playing the multi-player game. The game scores displayed on the public display 220b may be in form of numeric characters, a graphical representation, alphabetic characters and/or the like. Further, the processor 202, operatively coupled with the memory 204, is configured to store at least the game activities and the game scores of the players 102a-102d associated with the multi-player game for maintaining statistics of game play of the players 102a-102d of the multi-player game. In one embodiment, the processor 202 may be configured to transfer the gaming activities and the game scores of the players 102a-102d of the multi-player game to the database 112 via the gaming network 114 for storing and maintaining statistics of game play.

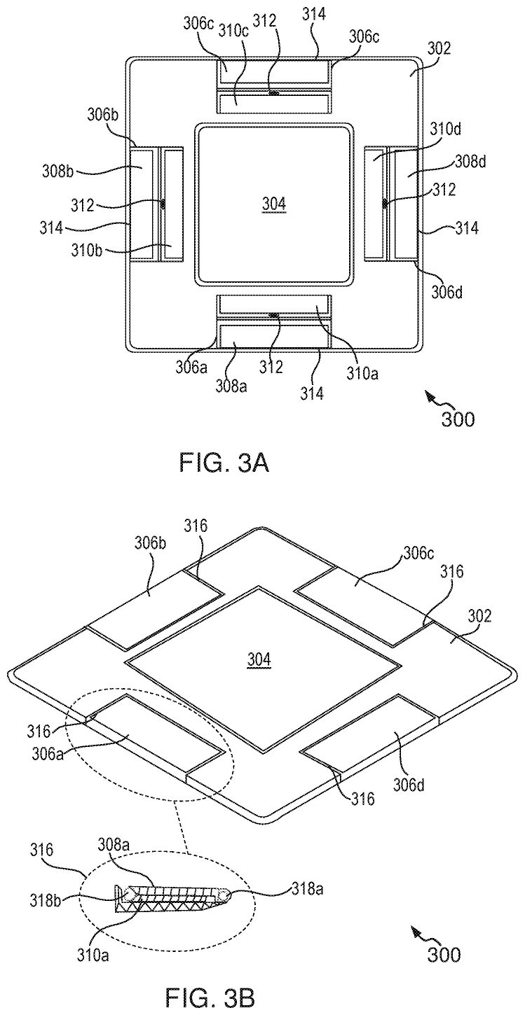

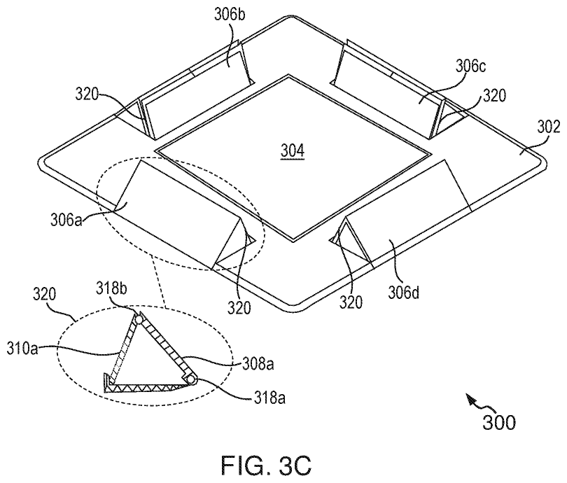

FIG. 3A illustrates a perspective top view of an electronic gaming board device 300 for the multi-player game, in accordance with an example embodiment of the present disclosure. For example, the electronic gaming board device 300 (hereinafter interchangeably referred to as “gaming board device 300”) is similar to the gaming board device 104 as shown and described with reference to FIG. 1. The gaming board device 300 includes a gaming board 302 for accommodating one or more structural components of the gaming board device 300. It shall be noted that, the gaming board device 300 configured with a square cross-section is shown for exemplary purposes only and the cross-section of the gaming board device 300 may vary to a circular cross-section or any other polygonal structure without losing scope of the present disclosure. The gaming board 302 may be a proprietary or conventional horizontal or frontal display including tablet, pc monitor, TV monitor, cellphones and the like.

In one embodiment, the gaming board device 300 includes a single common display (see, 304 of FIG. 3A) positioned substantially in a central portion of the gaming board 302. The common display 304 is configured to display a game layout or a published view of the multi-player game (e.g., Monopoly board, Checkers, Chess) to the plurality of players 102a-102d. For example, the common display 304 may be, but not limited to, a TFT-LCD (Thin film transistor-liquid crystal display), a Light-emitting diode display (LED), Plasma display panel (PDP), and Active Matrix Organic Light Emitting Diodes display (AMOLED) and the like.

In another embodiment, the gaming board device 300 may include a plurality of common displays (not shown in Figures) coupled together and positioned substantially on the central portion of the gaming board 302. The plurality of common displays may be coupled by some fastening mechanism, such as, but not limited to, a hinge, and/or a flexible backing tape as per the design feasibility and requirements. As such, coupling of plurality of common displays to form a single unit of the common display may increase area of the gaming layout that can accommodate more visual information related to the multi-player game. In this configuration, the gaming board device 300 may be configured to logically align the game layout for the multi-player game on the plurality of common displays.

In one embodiment, the multi-player game is played using the game board 302, where a plurality of players plays a multi-player game using a touch screen (or keypad, trackball, joystick, touchpad, etc.) on the game board 302. The common display 304 is configured to display shared “public” playing area.

Further, the gaming board 302 includes a plurality of player-specific displays 306a, 306b, 306c, and 306d mounted symmetrically on peripheral portions 314 of the gaming board 302. The gaming board 302 may be engraved symmetrically on peripheral portions 314 of the gaming board 302 for enveloping the plurality of player-specific displays 306a-306d. The plurality of player-specific displays 306a-306d is configured to operate between an open position (see, 320 of FIG. 3C) and a closed position (see, 316 of FIG. 3B) within the engraved portion of the gaming board 302 which is explained further in detail.

Each player-specific display (e.g., “player-specific display 306a”) is assigned to a player (e.g., “a player 102a”). The plurality of player-specific displays 306a-306d includes private displays 308a, 308b, 308c, and 308d and public displays 310a, 310b, 310c, and 310d, respectively (See, FIG. 3A).

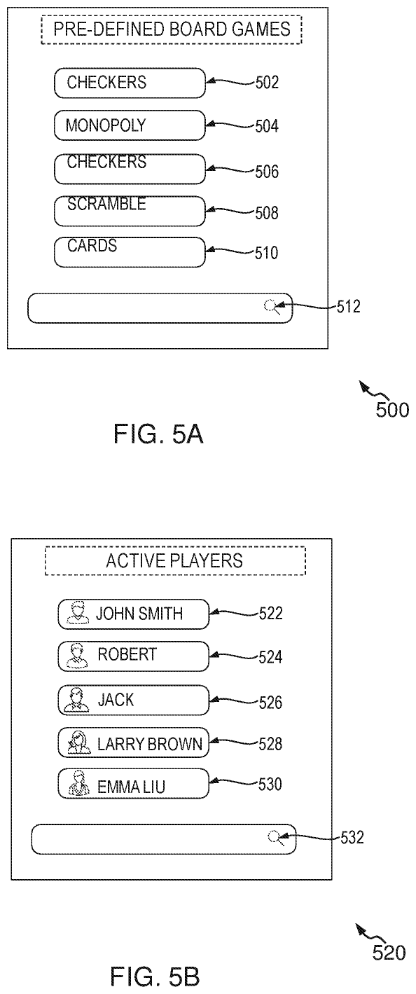

In an open configuration (see, 320 of FIG. 3C), the private display 308a is oriented towards the player 102a and the public display 310a is oriented towards competing players (e.g., “the players 102b-102d”) in the multi-player game. The private display 308a is configured to provide a user interface (see, 500 of FIG. 5A) for selecting a multi-player game from a list of predefined multi-player games, and the like. In other words, the private display 308a may be referred to as a gaming console associated with the player 102a.

The public display 310a is configured to display at least a player profile of the player 102a, leaderboard and the like. In some games, when it is important that all players should know each other assets/status (e.g. chips in Poker, cash in Monopoly, or score in many games), the public display corresponding to each player may show in their assets/status in addition to their names, colors etc.

In one embodiment, the private display 308a and the common display 304 are configured with a touchscreen technology. As such, the player 102a may interact and/or play the multi-player game with the competing players by providing a touch input either on the private display 308a and the common display 304.

The player-specific display (e.g., “player-specific display 306a”) may be used for a variety of functions, including, but not limited to, privately browsing game rules, consulting game strategies from available suggestions, consulting references (e.g., looking up a dictionary in a Scrabble game), taking private notes (e.g., in the Clue game), planning privately the next game steps, and optionally, for remotely controlling the game-specific pieces/objects on the gaming board. Additionally, the player-specific display (e.g., “player-specific display 306a”) is configured to display real-time game score data of the player (e.g., “player 102a”) on associated public display visible to the other players competing the multi-player game. One example for games suitable for this configuration is Battleships. In a Battleship game, the public playing area of the game is displayed on the common display 304, which is seen by all the participating players in private displays. However, individual players can see their “private” game-related information hidden from the other players in the private display (e.g., “the private display 308a”). Stratego is another example game suitable for this configuration.

In one embodiment, the player-specific display 306a may be a handheld device such as, a smart phone, a PDA, a personal media player, and the like which may be connected with the gaming board device 300 by using wired or wireless networks.

In one embodiment, each public display (e.g., public display 310a) includes an integrated camera device 312. The camera device 312 captures real-time images of the players competing in the multi-player game, thereby providing an interactive platform for engaging the players of the multi-player game.

In one embodiment, the camera device 312 may be mounted on the private display (e.g., “the private display 308a”) of each player-specific display (e.g., “the player-specific display 310a”).

Referring to FIG. 3B in conjunction with FIG. 3A, a schematic view of the gaming board device 300 is shown depicting the plurality of player-specific displays 306a-306d in the closed configuration (see, 316 in FIG. 3B).

As mentioned previously, the player-specific display (e.g., “player-specific display 306a”) includes the private display facing towards the player (e.g., “private display 308a”) and the public display facing towards the competing players (e.g., “public display 310a”) as described above.

In one embodiment, the player-specific display 306a is configured to open and close using a hinge mechanism. More particularly, the player-specific display 306a is swingably mounted on the peripheral portion 314 of the gaming board 302 by using a first hinge 318a. In other words, the player-specific display 306a is mounted on the gaming board 302 in a pivotable manner using the first hinge 318a. Further, the private display 308a and the public display 310a of the player-specific display 306a are swingably coupled together using a second hinge 318b.

In the closed configuration (see, 316), the private display 308a and the public display 310a of the player-specific display 306a overlap each other and are enveloped within the gaming board 302 using the hinge mechanism. In a more illustrative manner, the gaming board 302 envelops the player-specific display 306a such that the public display 310a faces downwards resulting into a planar-structure and/or a continuous flat display on the gaming board 302. In particular, collectively operating the first hinge 318a and the second hinge 318b enables the player 102a to reside the player-specific display 306a within the gaming board 302. Additionally, the closed configuration 316 disables the playing mode of the gaming board device 300. In this configuration, the entire portion of the game board 302 may be used as a touch screen platform due to orientation of the private display 308a of the player-specific display 306a and the common display 304 on the gaming board 302.

Referring to FIG. 3C in conjunction with FIG. 3A, a schematic view of the gaming board device 300 is shown depicting the plurality of player-specific displays 306a-306d in an open configuration (see, 320 of FIG. 3C). As such, prior to initiating the multi-player game, the player 102a manually orients the player-specific display 306a to the open configuration (see, 320 of FIG. 3C) which is called as the playing mode.

In the open configuration (see, 320), the first hinge 318a and the second hinge 318b are configured to provide an angular support to the private display 308a and the public display 310a associated with the players-specific display 306a and form a reverse “V” structure. In other words, in the open configuration (see, 320 of FIG. 3C), the private display 308a and the public display 310a are oriented at a preset angle. In a more illustrative manner, the orientation and configuration of the player-specific display 306a in the open configuration 320 conforms to a trilateral configuration. Additionally, the private display 308a is oriented towards the player 102a and the public display 310a is oriented towards the competing players 102b-102d of the multi-player game.

In one embodiment, a locking mechanism may also be coupled to at least the first hinge 318a and the second hinge 318b for locking the player-specific display 306a in the open configuration (see, 320 of FIG. 3C) at various preset angles.

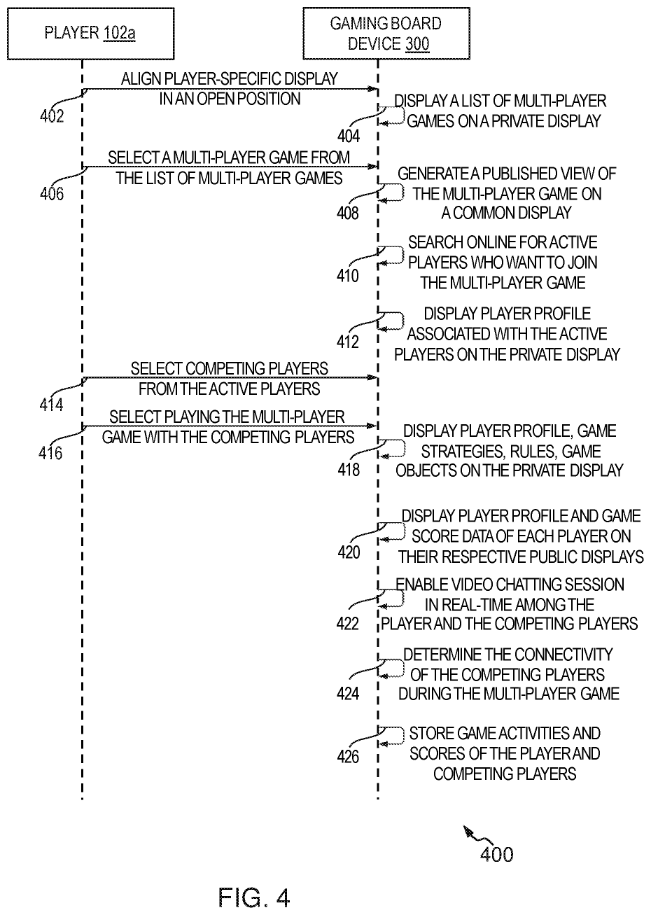

Referring now to FIG. 4, a flow diagram of a process 400 for facilitating a gaming and chatting session for players during playing the multi-player game using the gaming board device 300 (referring to FIG. 3A), is shown in accordance with an example embodiment of the present disclosure. The sequence of operations of the process 400 may not be necessarily executed in the same order as it is presented. Further, one or more operations may be grouped together and performed in the form of a single step, or one operation may have several sub-steps that may be performed in parallel or in a sequential manner. The process 400 begins at step 402.

At the step 402, for initiating the multi-player game, the player 102a associated with the gaming board device 300 manually aligns and/or lifts the plurality of player-specific displays 306a-306d to be in an open position (i.e., “open configuration”) from a closed position (i.e., “closed configuration”).

At step 404, the gaming board device 300 displays a list of stored predefined multiplayer games on the private display 308a. In one embodiment, the gaming board device 300 displays a list of stored predefined games on the common display 304.

At step 406, the player 102a selects the multi-player game from the list of predefined games for playing with players either located in remote locations. In one embodiment, the players can be presented physically for playing the multi-player game with the gaming board device 300. The player 102a may provide a touch input on the private display 308a for selecting the multi-player game from the list of pre-defined games.

At step 408, the gaming board device 300 generates a published view of the multi-player game on the common display 304 based on the selection.

At step 410, the gaming board device 300 searches online for active players, who want to join the multi-player game, through the gaming network 114

At step 412, the gaming board device 300 displays player profiles associated with the active players (i.e., “interested players”) on the private display 308a.

At step 414, the player 102a selects competing players (e.g., “the players 102b-102d) for playing the multi-player game. The competing players are associated with the player-specific displays 110b-110d. In one embodiment, the gaming board device 300 may manage players' position on the gaming board 302. In one embodiment, the private displays also enable the plurality of players to personalize his name, symbol, color, and position on the gaming board 302.

At step 416, the player 102a starts playing the multi-player game with the competing players 102b-102d using the gaming board device 300.

At step 418, the gaming board device 300 displays at least a player profile, game rules, game strategies, and digitized gaming objects associated with the player 102a on the private display 308a of the player-specific display 306a. The player 102a may provide a touch input on the private display 306a for playing the multi-player game. The actions and/or moves performed using digitized gaming objects related to the multi-player game may be selected by the player 102a on the private display 308a. Additionally, the gaming board device 300 communicates the action and/or moves on the common display 304 for playing the game with the competing players 102b-102d.

At step 420, the gaming board device 300 displays player profile and game score data of each player on the associated public display (e.g., “public display 310a”).

At step 422, the gaming board device 300 enables a video chatting session in real-time among the player 102a and the competing players 102b-102d during playing the multi-player game. In particular, the player 102a and the competing players 102b-102d connected via the gaming network 114 may interact through the video chatting platform using corresponding public displays 310a-310d. Consequently, live streaming experience provides the plurality of players of the multi-player game a smart and an interactive board gaming platform.

At step 424, the gaming board device 300 determines whether the competing players 102b-102d of the multi-player game are connected in the multi-player game. If it is determined that the plurality of players 102a-102d are connected in the multi-player game, the step 416 is performed. If it is determined that the connectivity of a player (e.g., “the player 102c”) for playing the multi-player game is lost and/or the player 102c wants the quit the game, the player 102c is dropped from the multi-player game.

At step 426, game activities and scores of the plurality of the players 102a-102d of the multi-player game are stored in the gaming board device 300 to maintain statistics of the game play. In one embodiment, the gaming board device 300 may transfer the gaming activities and scores of the plurality of players 102a-102d to the database 112 via the gaming network 114 for storing and maintaining statistics of game play.

FIGS. 5A, 5B, and 5C, collectively, represent example representations of user-interfaces (UI) displayed on a private display (e.g., “the private display 308a”) associated with each player-specific display (e.g., “player-specific display 306a”).

As shown in the FIG. 5A, a UI 500 is displayed on the private display 308a depicting a list of predefined board games. The gaming board device 300 displays a plurality of information fields 502, 504, 506, 508, and 510 on the private display 308a. The plurality of information fields 502, 504, 506, 508, and 510 corresponds to multi-player board games, such as, for example, ‘Checkers’, ‘Monopoly’, ‘Chess’, ‘Scrabble’ and ‘Cards’, respectively. The player 102a selects a multi-player game from the list of predefined board games. In one embodiment, the player 102a may provide a voice input and a gesture input on the UI 500 for selecting the multi-player game. Further, the UI 500 also includes a search field 512 for searching a particular board game by providing keywords into the search field 510.

As shown in the FIG. 5B, a UI 520 is displayed on the private display 308a to the player 102a for the selecting competing players from active players who want to join the multi-player game. In an example embodiment, the UI 520 is rendered by the gaming application on the public display 310a of the gaming board device 300 of FIG. 3. The UI 520 displays a plurality of information fields 522, 524, 526, 528, and 530 associated with the active players. Each information field includes at least a display picture field and a player name field. Further, the UI 520 also includes a search field 532 for searching players (e.g., “social friends”) not listed in the active players on the gaming network 114.

As shown in the FIG. 5C, a UI 540 is displayed on the private display 308a to the player 102a associated with the gaming board device 300 during playing the multi-player game. The gaming board device 300 renders the UI 540 including a display photo section 542 displaying a profile photo of the player 102a and a name section 544 displaying a name of the player 102a on the private display 308a.

The UI 540 includes a gaming section 546 for displaying private information such as but not limited to a game layout, gaming strategies, browsing electronic dictionary, and game rules. The UI 540 also includes one or more gaming objects 548 for playing the multi-player game with the competing players of the multi-player game. In one example, the gaming object 548 may be a dice 548a, and a directional touch screen controller 548b. The player 102a may perform operations on the gaming object 548 which facilitate corresponding actions on the common display 304 during playing the multi-player game. In one example, the player 102a selects a chess game for playing with the competing players 102b-102d. The game layout of the chess game may be displayed in the gaming section 546 on the UI 540. When the player's turn arrivers as part of game play, the player (for example, the player 102a) uses the directional touch screen controller 548b for facilitating corresponding action on at least one coin of the chess game on the common display 304 for playing the game with the competing players 102b-102d.

The UI 540 further includes an option 550 associated with text ‘EXIT’. The player 102a may select the option 550 by providing the touch input for disconnecting from the multi-player game.

It shall be noted that the UIs 500, 520, and 540 may include more contents than those shown in FIGS. 5A to 5C. The UIs of FIGS. 5A to 5C are described herein for explanation purpose and may vary without losing scope of the present disclosure.

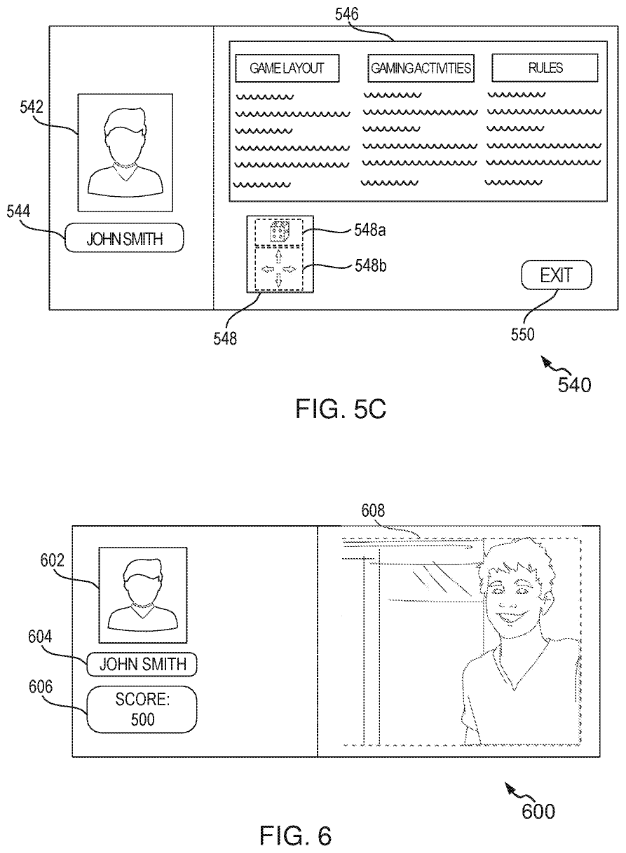

FIG. 6 is an example representation of a user-interface (UI) displayed on a public display (e.g., “the public display 310a”) associated with each player-specific display (e.g., “the player-specific display 306a”) associated with the multi-player game. The UI 600 of FIG. 6 is described herein for explanation purpose and may vary without losing scope of the present disclosure.

In the playing mode, the gaming board device 300 is configured to display player profiles and game scores associated with each player on his/her corresponding public display. The UI 600 includes a profile photo section 602 and a player name section 604 (e.g., JOHN SMITH) of the player 102a. Further, the UI 600 includes a game score section 606 (e.g., “500”) for displaying scores of the competing players 102b-102d on their respective public displays during the multi-player game.

Further, the UI 600 provides a video chatting platform 608 for interacting with the competing players (i.e., “competing players 102b-102d”). The video chatting platform 610 provides a live-streaming video of the competing players of the gaming board device 300 during the multi-player game. More specifically, the player 102a may interact with the competing players 102b-102d during the multi-player game through the video chatting session in real-time (i.e., live-streaming) rendered on the video chatting platform 610. Consequently, the live streaming experience provides the players of the multi-player game a smart and interactive platform.

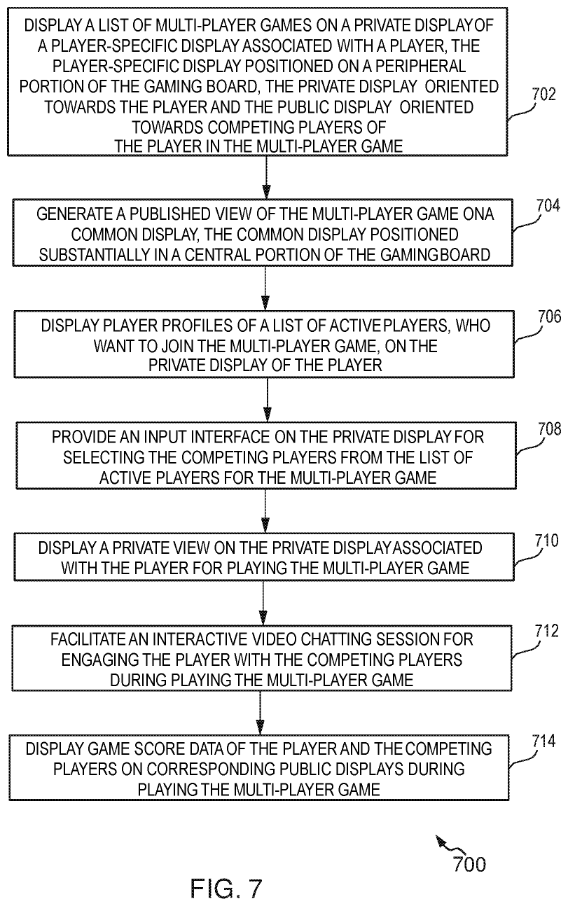

FIG. 7 illustrates a flow chart of a method 700 for playing the multi-player game by using the electronic gaming board device 300, in accordance with an example embodiment of the present disclosure. The method 700 depicted in the flow graph may be executed by a processor, for example, a processor embodied in an electronic gaming board device 300 of FIG. 3A. The sequence of operations of the method 700 may not be necessarily executed in the same order as it is presented. Further, one or more operations may be grouped together and performed in the form of a single step, or one operation may have several sub-steps that may be performed in parallel or in a sequential manner. The method 700 starts at operation 702.

At operation 702, the method 700 includes displaying a list of multi-player games on a private display (e.g., “private display 308a”) of a player-specific display (e.g., “player-specific display 306a”) associated with a player (e.g., “the player 102a”). The player-specific display 306a is positioned on a peripheral portion 314 of the gaming board 302 and includes the private display and a public display (e.g., “the public display 310a”). The private display 308a is oriented towards the player 102a and the public display 310a is oriented towards competing players of the player 102a in the multi-player game.

At operation 704, the method 700 includes generating a published view of the multi-player game on a common display (e.g., “a common display 304”). The common display 304 is positioned substantially in a central portion of the gaming board 302.

At operation 706, the method 700 includes displaying player profiles of a list of active players, who want to join the multi-player game, on the private display 308a of the player 102a.

At operation 708, the method 700 includes providing an input interface on the private display 308a to the player 102a for selecting the competing players from the list of active players for the multi-player game.

At operation 710, the method 700 includes displaying a private view on the private display associated with the player for playing the multi-player game. The private view may comprise, but is not limited to, gaming rules, gaming strategies, remaining gaming assets, and digitized gaming objects.

At operation 712, the method 700 includes facilitating an interactive video chatting session for engaging the player with the competing players during playing the multi-player game.

At operation 714, the method 700 includes displaying game score data of the player and the competing players on corresponding public displays during playing the multi-player game

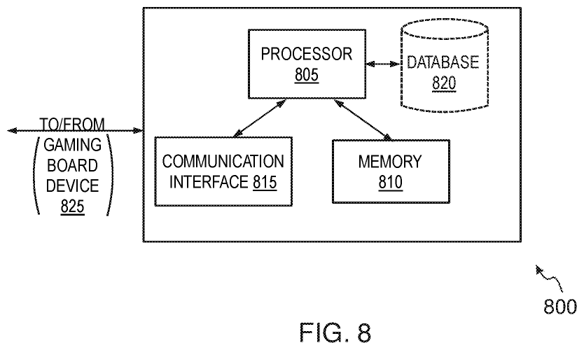

FIG. 8 illustrates a block diagram representation of a gaming server 800 capable of implementing at least some embodiments of the present disclosure. The gaming server 800 may correspond to the gaming server 116 as shown and described with reference to FIG. 1. The gaming server 800 is configured to host and manage a gaming application (e.g., the gaming application 214 of FIG. 2) that is provided to an electronic device, such as the electronic gaming board device 300 of FIG. 3A, in accordance with an example embodiment of the present disclosure.

The gaming server 800 includes a processor 805 configured to execute one or more executable instructions stored in a memory 810. Further, the gaming server 800 includes a communication interface 815. The components of the gaming server 800 provided herein may not be exhaustive and that the gaming server 800 may include more or fewer components than that of depicted in FIG. 8. Further, two or more components may be embodied in one single component, and/or one component may be configured using multiple sub-components to achieve the desired functionalities. Some components of the gaming server 800 may be configured using hardware elements, software elements, firmware elements and/or a combination thereof.

The processor 805 is operatively coupled to the communication interface 815 that provides communication with a remote device 825, such as the gaming board device 300. The processor 805 is configured to search for a list of active players (e.g., “competing players 102b-102d”) available for the multi-player game. As such, the processor 805 communicates the list of competing players available for the multi-player game to the player (e.g., “the player 102a”) using the communication interface 815. Further, the processor 805 may be configured to continuously track connectivity of the plurality of players 102a-102d associated with the multi-player game for enabling the plurality of players 102a-102d to play the multi-player game in real time. In one example scenario, the communication interface 815 is configured to receive a request from the player (e.g., “player 102a”) through the gaming board device 300 via the gaming network 114 for resuming the multi-player game at a later time.

In one example embodiment, the gaming server 800 may receive a request from the player via the communication interface 815 for disconnecting the player (e.g., “player 102a”) from the multi-player game. Further, the processor 805 is configured to render the video chatting session in real-time to the players while playing the multi-player game. In another embodiment, the gaming server 800 is configured to receive the game activities and scores of the plurality of players associated with the multi-player game via the communication interface 815 for storing in a database 820.

The database 820 is any computer-operated hardware suitable for storing and/or retrieving data, such as, but not limited to, the game activities and scores of the plurality of players associated with the multi-player game and the like. The database 820 may include multiple storage units such as hard disks and/or solid-state disks in a redundant array of inexpensive disks (RAID) configuration. The database 820 may include a storage area network (SAN) and/or a network attached storage (NAS) system. In some alternate embodiments, the database 820 may also include magnetic storage devices (such as hard disk drives, floppy disks, magnetic tapes, etc.), optical magnetic storage devices (e.g., magneto-optical disks), semiconductor memories (such as mask ROM, PROM (programmable ROM), EPROM (erasable PROM), Phase-change memory, flash ROM, RAM (random access memory)), etc.

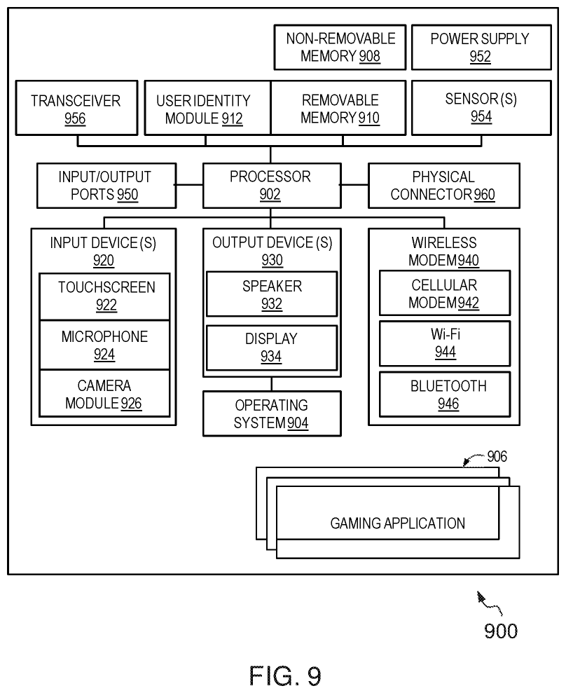

FIG. 9 shows a simplified block diagram of a user device 900 for example a tablet or a smart board of implementing the various embodiments of the present disclosure. For example, the user device 900 may correspond to the gaming board device 104 of FIG. 1. The user device 900 is depicted to include one or more applications such as a gaming application 906 which is an example of the gaming application 214 of FIG. 2. The gaming application 906 can be an instance of an application downloaded from the gaming server 116 or a third-party server. The gaming application 906 implements game layout on the user device 900 and is capable of communicating with the gaming server 116 for facilitating an integrated gaming and chatting session.

It should be understood that the user device 900 as illustrated and hereinafter described is merely illustrative of one type of device and should not be taken to limit the scope of the embodiments. As such, it should be appreciated that at least some of the components described below in connection with that the user device 900 may be optional and thus in an example embodiment may include more, less or different components than those described in connection with the example embodiment of the FIG. 9. As such, among other examples, the user device 900 could be any of a mobile electronic gaming board device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the user device 900 and support for one or more gaming applications programs (see, the gaming applications 906) such as the gaming application, that implements one or more of the innovative features described herein. In addition, to the gaming application, the gaming applications 906 may include common mobile computing applications (e.g., telephony applications, email applications, calendars, contact managers, web browsers, messaging applications) or any other computing application.

The illustrated user device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the gaming applications 906. The user device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), and a camera module 926 (e.g., capable of capturing still picture images and/or video images). Examples of the output devices 930 may include, but are not limited to a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in the FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the user device 900 and a public switched telephone network (PSTN).

The user device 900 can further include one or more input/output ports 950, a power supply 952, one or more sensors 954 for example, an accelerometer, a gyroscope, a compass, or an infrared proximity sensor for detecting the orientation or motion of the user device 900 and biometric sensors for scanning biometric identity of an authorized user, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed method with reference to FIG. 7, or one or more operations of the method 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the present disclosure has been described with reference to specific exemplary embodiments, it is noted that various modifications and changes may be made to these embodiments without departing from the broad spirit and scope of the present disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the gaming server 800 and its various components such as the processor 805 and the database 820 may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor 805 or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the present disclosure, as discussed above, may be practiced with steps and/or operations in a different order, and/or with hardware elements in configurations, which are different than those which, are disclosed. Therefore, although the present disclosure has been described based upon these exemplary embodiments, it is noted that certain modifications, variations, and alternative constructions may be apparent and well within the spirit and scope of the present disclosure.

Although various exemplary embodiments of the present disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. An electronic gaming board device for a multi-player game, comprising:
a gaming board;
a common display positioned substantially in a central portion of the gaming board, the common display visible to a plurality of players competing in the multi-player game; and
a plurality of player-specific displays, each player-specific display mounted on a peripheral portion of the gaming board at player positions associated with the plurality of players, and each player-specific display of the plurality of player-specific displays comprising a private display and a public display,
wherein in a playing mode of the multi-player game, the private display is oriented towards a player and the public display is oriented towards competing players of the player in the multi-player game.

2. The electronic gaming board device of claim 1, wherein each player-specific display is swingably mounted on the peripheral portion of the gaming board using a first hinge, and wherein the private display and the public display of each player-specific display are swingably coupled together using a second hinge.

3. The electronic gaming board device of claim 2, wherein the first and second hinges are configured to facilitate overlapping of the private and public displays with each other in a closed position and provide an angular support to the private and public displays in an open position.

4. The electronic gaming board device of claim 3, wherein in the closed position, the private and public displays are enveloped into the gaming board to form a continuous flat display.

5. The electronic gaming board device of claim 3, wherein in the open position, the private and public displays are opened angularly along the second hinge, and wherein in the open position, the electronic gaming board device is configured to operate in the playing mode.

6. The electronic gaming board device of claim 1, further comprising:
a memory storing executable instructions; and
a processor configured to execute the instructions stored in the memory to cause the electronic gaming board device to perform at least:
display a list of multi-player games on the private display associated with the player for selecting the multi-player game,
generate a published view of the multi-player game on the common display,
display player profiles of a list of active players, who want to join the multi-player game, on the private display of the player,
provide an input interface on the private display for selecting the competing players from the list of active players for the multi-player game, and
display game score data of the player and the competing players on corresponding public displays during playing the multi-player game.

7. The electronic gaming board device of claim 1, further comprising:
a camera device mounted on the public display of each player-specific display; and
an audio transceiver, wherein the camera device and the audio transceiver are configured to provide an interactive video chatting session for engaging the player with the competing players during playing the multi-player game.

8. The electronic gaming board device of claim 1, wherein the common display and the private display associated with each player-specific display are configured with a touchscreen technology, and wherein the private display associated with each player-specific display is configured to display a private view of the multi-player game.

9. A non-transitory computer readable storage medium including computer executable code for playing a multi-player game using an electronic gaming board device, the electronic gaming board device comprising a gaming board, the computer executable code being executed by a processor, the non-transitory computer readable storage medium comprising one or more instructions, the one or more instructions causing the processor to perform at least:
display a list of multi-player games on a private display of a player-specific display associated with a player, the player-specific display positioned on a peripheral portion of the gaming board and comprising the private display and a public display, the private display oriented towards the player and the public display oriented towards competing players of the player in the multi-player game;
generate a published view of the multi-player game on a common display, the common display positioned substantially in a central portion of the gaming board;
display player profiles of a list of active players, who want to join the multi-player game, on the private display of the player;
provide an input interface on the private display for selecting competing players from the list of players for the multi-player game;
display a private view on the private display associated with the player for playing the multi-player game;
facilitate an interactive video chatting session for engaging the player with the competing players during playing the multi-player game; and
display game score data of the player and the competing players on corresponding public displays during playing the multi-player game.

10. The non-transitory computer readable storage medium of claim 9, wherein the processor of the electronic gaming board device is further caused to:
determine via a gaming network, the list of active players who wants to join the multi-player game.

11. The non-transitory computer readable storage medium of claim 10, wherein the processor of the electronic gaming board device is further caused to:
store gaming activities and game score data of the player and the competing players associated with the multi-player game in a database via the gaming network for storing and maintaining statistics of game play.

12. The non-transitory computer readable storage medium of claim 10, wherein the processor of the electronic gaming board device is further caused to:
determine connectivity of the competing players during playing the multi-player game.

13. The non-transitory computer readable storage medium of claim 9, wherein the private view comprises information related to at least gaming rules, gaming strategies, game layout, and digitized gaming objects.

14. The non-transitory computer readable storage medium of claim 9, wherein the common display is visible to the player and the competing players associated with the multi-player game.

15. An electronic gaming board device for a multi-player game, comprising:
a gaming board;
a common display positioned on a substantially central portion of the gaming board, the common display visible to a plurality of players competing in the multi-player game;
a plurality of player-specific displays, each player-specific display is mounted on a peripheral portion of the gaming board at player positions associated with the plurality of players, and each player-specific display of the plurality of player-specific displays comprising a private display and a public display,
wherein each player-specific display is swingably mounted on the peripheral portion of the gaming board using a first hinge, and wherein the private display and the public display of each player-specific display are swingably coupled together using a second hinge,
wherein in a playing mode of the multi-player game, the private display is oriented towards a player and the public display is oriented towards competing players of the player in the multi-player game;
a memory storing executable instructions; and
a processor configured to execute the instructions stored in the memory to cause the electronic gaming board device to perform at least:
display a list of multi-player games on the private display associated with the player for selecting the multi-player game,
generate a published view of the multi-player game on the common display,
display player profiles of a list of active players, who want to join the multi-player game, on the private display of the player,
provide an input interface on the private display for selecting the competing players from the list of active players for the multi-player game, and
display game score data of the player and the competing players on corresponding public displays during playing the multi-player game.

16. The electronic gaming board device of claim 15, wherein the first and second hinges are configured to facilitate overlapping of the private and public displays with each other in a closed position and provide an angular support to the private and public displays in an open position.

17. The electronic gaming board device of claim 15, wherein in the closed position, the private and public displays are enveloped into the gaming board to form a continuous flat display.

18. The electronic gaming board device of claim 15, wherein in the open position, the private and public displays are opened angularly along the second hinge, and wherein in the open position, the electronic gaming board device is configured to operate in the playing mode.

19. The electronic gaming board device of claim 15, further comprising:
a camera device mounted on the public display of each player-specific display; and
an audio transceiver, wherein the camera device and the audio transceiver are configured to provide an interactive video chatting platform for engaging the player with the competing players during the multi-player game.

20. The electronic gaming board device of claim 15, wherein the common display and the private display associated with each player-specific display are configured with a touchscreen technology, and wherein the private display associated with each player-specific display is configured to display a private view of the multi-player game.
